(19) United States
(12) Patent Application Publication
(10) Pub. No.: US 2025/0079482 A1
(43) Pub. Date: Mar. 6, 2025

(54) HUMIDIFIER

(71) Applicant: MAHLE International GmbH, Stuttgart (DE)

(72) Inventors: Michael Baumann, Ammerbuch (DE); Sven Alexander Kaiser, Waiblingen (DE); Aleksandar Radlovic, Stuttgart (DE); Beata Scheinoch, Spraitbach (DE); Martin Wabschke, Kornwestheim (DE)

(21) Appl. No.: 18/038,002

(22) PCT Filed: Nov. 9, 2021
(86) PCT No.: PCT/EP2021/081119

§ 371 Date: May 19, 2023

(30) Foreign Application Priority Data
Nov. 20, 2020 (DE) 10 2020 214 626.8
Feb. 9, 2021 (DE) 10 2021 201 217.5

(51) Int. Cl. H01M 8/04119; B01D 63/08

(52) U.S. Cl. CPC H01M 8/04149; B01D 63/082; B01D 2313/042; B01D 2313/143

(57) ABSTRACT

A humidifier for humidifying a first fluid via a second fluid a plurality of membranes and a plurality of spacers. The plurality of membranes may be arranged following one another in a stacking direction. The plurality of spacers may include a plurality of first spacers and a plurality of second spacers arranged alternately between the plurality of membranes in the stacking direction. The plurality of spacers may space the plurality of membranes apart with respect to one another. A first height of the plurality of first spacers extending in the stacking direction may be smaller than a second height of the plurality of second spacers extending in the stacking direction. A ratio of the second height to the first height may be at least 1.2.

### CROSS-REFERENCE TO RELATED APPLICATIONS

This application claims priority to International Patent Application No. PCT/EP2021/081119, filed on Nov. 9, 2021, German Patent Application No. DE 10 2020 214 626.8, filed on Nov. 20, 2020 and German Patent Application No. DE 10 2021 201 217.5, filed on Feb. 9, 2021, the contents of all of which are hereby incorporated by reference in their entirety.

### TECHNICAL FIELD

The present invention relates to a humidifier with a plurality of membranes arranged following one another in a stacking direction, for humidifying a first fluid by means of a second fluid.

### BACKGROUND

In a humidifier during operation a first fluid is humidified by means of a second fluid. Such humidifiers are used for example in fuel cell systems, in order to transfer the humidity, present (in) exhaust gas occurring in operation of an associated fuel cell to the air which is to be supplied to the fuel cell and to thus humidify the air.

For this purpose, such humidifiers usually have membranes which follow one another. One of the fluids flows respectively along sides of the membranes which face away from one another, so that the membranes permit an exchange of humidity between the fluids. In order to achieve a flowing of the fluids along the sides of the membranes, the membranes are spaced apart from one another in their spacing direction. Basically, the structure of such a humidifier can be realized in the successive arranging of several units, which respectively comprise at least one membrane. These units, which are respectively also designated as a stacking unit in the following, are usually stacked on one another.

The spacing of the membranes with respect to one another usually takes place respectively by means of an arrangement having several parts, which is able to be flowed through.

DE 10 2012 014 723 Al shows a corresponding stacking unit and the associated humidifier. The stacking unit comprises a membrane with two sides facing away from one another, via which humidity is exchanged during operation. On a first of the sides, a first arrangement, able to be flowed through, is arranged, and on a second of the sides a second arrangement, able to be flowed through, is arranged, in order to space the successive membranes of the humidifier apart with respect to one another. The first arrangement comprises a flow layer. In contrast, the second arrangement comprises, in addition to a flow layer, respectively a support structure, on both sides of the flow layer, with a plurality of through-openings. This leads to a complex construction and production of the stacking unit and of the humidifier, constructed in a complex manner.

DE 10 2012 218 303 Al shows a humidifier for a fuel cell with membranes and flow layers arranged alternately in a stacking direction.

### SUMMARY

The present invention is therefore concerned with the problem of indicating for a humidifier of the type described above improved or at least other embodiments which are distinguished in particular by a simple and economical construction and/or an increased efficiency.

This problem is solved according to the invention by the subject matter of the independent claim(s). Advantageous embodiments are the subject matter of the dependent claim(s).

The present invention is based on the general idea, in a humidifier, of configuring the distance between successive membranes respectively by means of a spacer in an alternately smaller and larger manner, so that the distance has alternately a first size and a larger second size compared to the first size. In this way, the successive spaces between the membranes are alternately large and small.

Here in particular use is made of the knowledge that the larger space is only required on one side of the respective membrane, in order to transport excess moisture and/or condensate and/or water vapour away from this side, whereas on the other side of the membrane this enlarged space is not needed. With the transporting away of the moisture and/or of the condensate and/or of the water vapour from the associated spaces, a corresponding occupying of these spaces with condensate or respectively water and/or an increased flow resistance in these spaces and/or a sticking of the membranes to one another is prevented or at least reduced. Consequently, the efficiency of the humidifier is increased and/or the pressure loss is reduced. At the same time, through the smaller configuration of the other spaces, the requirement for installation space is reduced. This results in that the humidifier is constructed in a more compact manner. In addition, thus in the same volume an increased number of membranes can be arranged, so that the efficiency of the humidifier is increased. The use respectively of a spacer for spacing the membranes apart with respect to each other leads, in addition, to a simplified structure and an economical production of the humidifier.

The humidifier therefore has membranes following one another in one direction, wherein this direction is also designated below as stacking direction. The respective membrane has sides facing away from one another in stacking direction, via which one of the fluids transfers moisture to the other fluid. In the humidifier respectively one of the sides of one of the membranes and a side of the next adjacent membrane are facing one another. Membranes following one another in stacking direction are spaced apart from one another here in stacking direction alternately by a first spacer and a second spacer. Preferably, the respective spacer lies on both adjacent sides of the associated membranes.

The first spacers have a height in stacking direction, which is also designated below as first height. The second spacers have a height in stacking direction, which is also designated below as second height. Here, the first height is smaller than the second height.

The respective membrane is expediently permeable to moisture, in order to permit an exchange of moisture between the fluids.

It is preferred if a flow path of a first fluid, also designated below as first flow path, runs in the humidifier between the sides of the membranes which are spaced apart with respect to one another by means of the first spacers and are facing one another. It is further preferred if a flow path of the second fluid, also designated below as second flow path, separated from the first flow path, runs between the sides of the membranes which are spaced apart with respect to one another by means of the second spacers and are facing one another. The second flow path therefore runs between the sides of the successive membranes further spaced with respect to one another. Particularly preferably, the second fluid is the fluid which in the humidifier transfers moisture to the first fluid via the sides of the membranes.

Here, the first flow path and the second flow path can run relative to one another transversely through the humidifier. This can be realized for example by a corresponding arrangement of the adhesive strips.

The respective spacer is preferably able to be flowed through. Thus, a simplified flow is achieved along the respectively associated sides of the membranes. In particular, it is conceivable to configure the respective spacer as a grid structure which is able to be flowed through, in which grid bars run transversely to the stacking direction and transversely to one another.

At least one of the spacers, advantageously the respective spacer, is in one piece, has in particular a symmetrical structure and/or is cohesive and/or is formed from the same substance and/or material.

The membranes can be identical.

The sides of the membranes are preferably large sides and/or flat sides of the membranes. The membranes are therefore flat in construction and therefore have large outer sides facing away from one another, wherein these large outer sides are the sides of the membranes facing one another in stacking direction, which are spaced apart from one another by means of the spacers. Thus for the transfer of moisture from the second to the first fluid, an enlarged area is provided and at the same time a compact structure of the humidifier is achieved.

The idea according to the invention can be realized by the stacking of stacking units on one another.

The respective stacking unit can have two membranes. The stacking unit further comprises a first spacer and a second spacer. One of the spacers, for example the first spacer, is arranged between two sides of the membranes which face one another and thus spaces the membranes apart with respect to one another. The other spacer, for example the second spacer, is arranged on the side of one of the membranes facing away from the first-mentioned spacer, therefore for example the first spacer, and serves for spacing the stacking unit to a membrane of an adjacent stacking unit in stacking direction. Here, the first spacer has a first height running in stacking direction, which is smaller than a second height of the second spacer running in stacking direction.

The idea according to the invention can be realized alternatively by the alternating stacking on one another of first stacking units and second stacking units. The first stacking unit has a membrane and a first spacer which is arranged on a side of the membrane and serves for the spacing of the membrane to the membrane of the adjacent second stacking unit. The second stacking unit has a membrane and a second spacer, which is arranged on a side of the membrane and serves for the spacing of the membrane to the membrane of the adjacent first stacking unit. Here, the first spacer has a first height running in stacking direction, which is smaller than a second height of the second spacer running in stacking direction.

The ratio of the second height to the first height is at least 1.2. The second height is therefore preferably at least 20% greater than the first height.

Advantageously, the ratio of the second height to the first height is between 1.2 and 3.0. The second height is therefore advantageously at least 20% and 300% greater than the first height.

In the humidifier, in particular in the respective stacking unit, adhesive strips are advantageously provided, which stick the successive membranes to one another.

The respective adhesive strip is advantageously arranged adjacent to an associated one of the spacers in a margin region of the associated membranes. This can be achieved in that at least one of the spacers extends transversely to the stacking direction over a, preferably central, partial portion of one of the at least one next adjacent membranes, so that a partial area remains free transversely to the stacking direction at at least one margin region of the side of the membrane. An adhesive strip is mounted here at the margin region, which adhesive strip extends along the margin region and sticks to one another the membranes which follow one another in stacking direction.

The adhesive strips adjacent to the first spacers transversely to the stacking direction preferably have a first thickness which is smaller than a second thickness, running in stacking direction, of the adhesive strips adjacent to the second spacers transversely to the stacking direction.

Particularly preferably, the first thickness corresponds to the first height and/or the second thickness corresponds to the second height.

Advantageously, the respective adhesive strip seals along its extent the associated spacer fluidically transversely to the stacking direction and thus towards the exterior.

The humidifier can basically be used in any desired application for humidifying a corresponding fluid.

Advantageously, the spacers of the same type are configured identically. This means that the first spacers are configured identically, and/or that the second spacers are configured identically.

In particular, the humidifier is used in a fuel cell system which has at least one fuel cell. In operation, the fuel cell is supplied with an oxygen-containing reactant, for example air, and with a hydrogen-containing reactant, and generates a moist exhaust gas, in particular containing water vapour. The humidifier is preferably used in order to transfer the moisture contained in the exhaust gas to the oxygen-containing reactant. The exhaust gas is therefore here the second fluid, and the oxygen-containing reactant, for example air, is the first fluid.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained more closely in the following description, wherein the same reference numbers refer to identical or similar or functionally identical components.

### BRIEF DESCRIPTION OF THE DRAWINGS

There are shown, respectively schematically

FIG. 1 shows an isometric view of a humidifier,

FIG. 2 shows an enlarged view of the region designated by II in FIG. 1,

FIG. 3 shows an enlarged view of the region designated by III in FIG. 2,

FIG. 4 shows an isometric view of a first stacking unit of the humidifier,

FIG. 5 shows an isometric view of a second stacking unit of the humidifier,

FIG. 6 shows a side view of the second stacking unit,

FIG. 7 shows a side view of the first stacking unit,

FIG. 8 shows a section through another example embodiment of a stacking unit,

FIG. 9 shows a section through a further example embodiment of the stacking unit,

FIG. 10 shows a highly simplified illustration, in the manner of a circuit diagram, of a fuel cell system with the humidifier.

### DETAILED DESCRIPTION

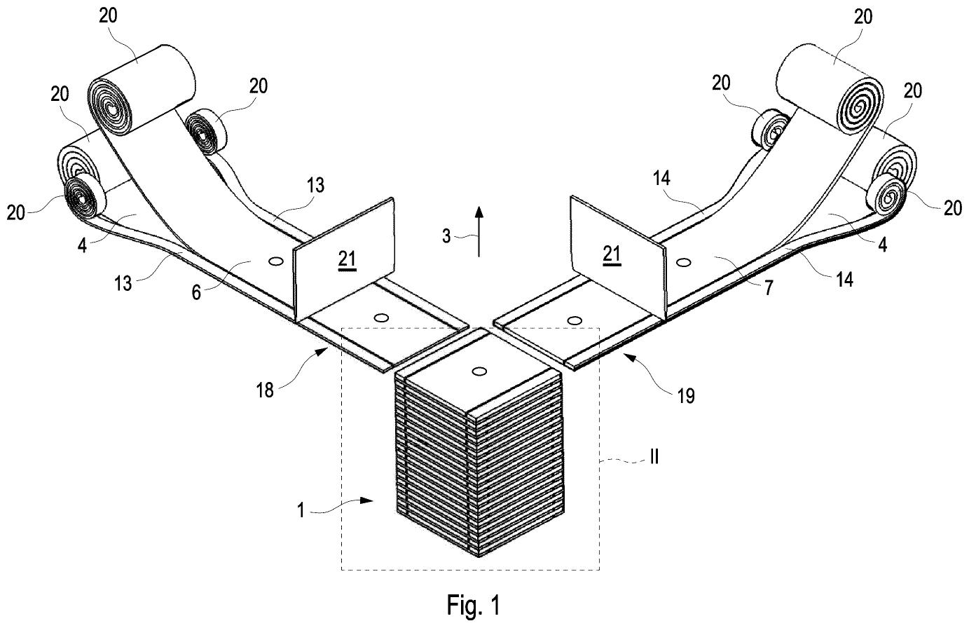

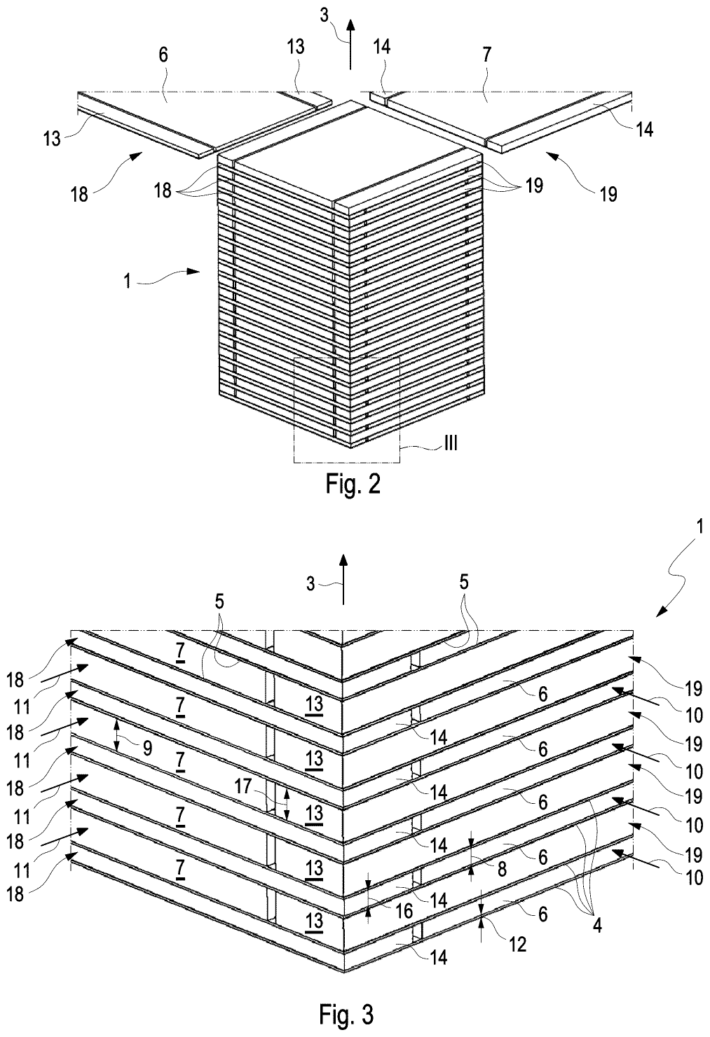

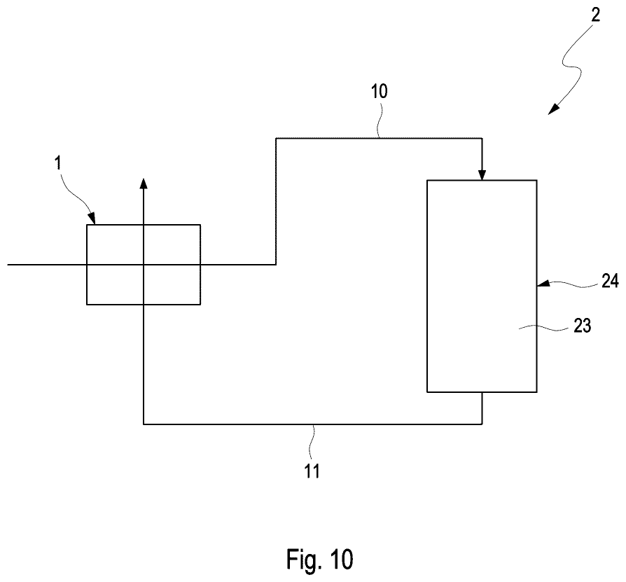

A humidifier 1, as is shown in FIGS. 1 to 3 and 10, is used for example in a fuel cell system 2, as is illustrated in a highly simplified manner and in the manner of a circuit diagram, in FIG. 10.

As can be seen in particular from FIGS. 1 to 3, the humidifier 1 has several membranes 4 following one another in a stacking direction 3. Via the membranes 4, a first fluid and a second fluid can exchange moisture, so that one of the fluids is humidified. The respective membrane 4 has two sides 5, facing away from one another in stacking direction 3, via which the exchange of moisture takes place. In the example embodiments which are shown, and preferably, the membranes 4 have a flat shape, wherein the sides 5 form large outer surfaces of the flat membranes 4. In stacking direction 3 therefore respectively a side 5 of a membrane 4 is arranged lying opposite a side 5 of the next adjacent membranes 4. The sides 5, lying opposite one another, and thus the membranes 4, are spaced apart from one another via spacers 6, 7. Here, as can be seen in particular from FIG. 3, a first spacer 6 and a second spacer 7 are arranged alternately in stacking direction 3. As can be seen in addition in particular from FIG. 3, the first spacers 6 have a height 8 running in stacking direction 3, also designated below as first height 8. The second spacers 7 have a height 9 running in stacking direction 3, also designated below as second height 9. As can be seen for example from FIG. 3, the first height 8 here is smaller than the second height 9. This has the result that the membranes 4 or respectively their sides 5, facing one another, are spaced apart in stacking direction 3 alternately nearer and further with respect to one another. The humidifier 1 is configured here such that the flow path 10 of the first fluid, indicated in FIGS. 3 and 10, also designated below as first flow path 10, runs between the sides 5 of the membranes 4 spaced apart from one another by means of the first spacers 6 and facing one another. In addition, the humidifier 1 is configured such that a flow path 11 of the second fluid, also designated below as second flow path 11, separate from the first flow path 10, runs between the sides 5 of the membranes 4 spaced apart from one another by means of the second spacers 7 and facing one another. The second fluid concerns here preferably the fluid which in operation of the humidifier 1 transfers moisture to the first fluid. In this way, a compact construction of the humidifier 1 is achieved with, at the same time, a simplified discharging of excess moisture or respectively condensate and/or water vapour from the humidifier 1. Here, use is made of the knowledge that between the membranes 4 along the second flow path 11 and thus the flow path 11 of the fluid, which already contains moisture, excess moisture or respectively condensate and/or water, jointly designated below as moisture, occur and thus can lead to a reduction of the efficiency of the humidifier 1. Through the enlarged distance of the sides 5 of the membranes 4 delimiting the second flow path, an improved discharging of this excess moisture takes place and thus an increased efficiency and a reduced pressure loss. At the same time, through the reduced distance of the sides 5 of the membranes 4 delimiting the first flow path 10, a more compact structure of the humidifier 1 is achieved, which also permits more membranes 4 in the same volume as a whole to be arranged in the humidifier 1 and thus permits the efficiency of the humidifier 1 to be further increased.

The humidifier 1 expediently comprises a housing, which is not shown, in which the membranes 4 and the spacers 6, 7 are accommodated.

As can be seen from the figures, the membranes 4 are configured in an identical manner in the example embodiments which are shown. Here, a thickness 12 of the membranes 4, running in stacking direction 3, is considerably smaller than the heights 8, 9.

The ratio of the second height 9 to the first height 8 is at least 1.2. This means that the respective second height 9 is at least 20% greater than the respective first height 8. In particular, the ratio of the second height 9 to the first height 8 is between 1.2 and 3. This means that the respective second height 9 is preferably between 20% and 300% greater than the respective first height 8. In this way, a particularly effective discharging of excess moisture is achieved with, at the same time, a compact design of the humidifier 1.

As can be seen in particular from FIGS. 1 to 7, in the example embodiments which are shown the spacers 6, 7 lie respectively on the sides 5, which they space apart from one another respectively, also designated below as associated sides 5. The spacers 6, 7 are able to be flowed through here, so that the respective fluid can flow through them. For this purpose, the spacers 6, 7 can have, for example, a grid structure which is not shown. The spacers 6, 7 are illustrated in the figures respectively as a block, in order to better represent their different heights 8, 9. However, as mentioned above, they are respectively able to be flowed through.

As can be seen in particular from FIGS. 1 to 7, the respective spacer 6, 7 extends over a partial portion of the associated sides 5, so that the spacer 6, 7 transversely to the stacking direction 3 frees at least one margin region 15 of the associated sides 5. In the example embodiments which are shown, the respective spacer 6, 7 is arranged centrally with respect to the associated sides 5, so that it frees two margin regions 15 spaced apart from one another transversely to the stacking direction 3, whereas along the margin regions 15 transversely to the stacking direction 3 it extends along the entire extent of the associated sides 5. The membranes 4 are stuck to one another here via the margin regions 15 by means of adhesive strips 13, 14. For this purpose, an adhesive strip 13, 14 is mounted at least at one of the margin regions 15 at least of one of the sides 5 of the membranes 4 which face one another. In the example embodiments which are shown, the respective adhesive strip 13, 14 here is a double-sided adhesive strip 13, 14, so that the membranes 4 are stuck to one another by means of the adhesive strips 13, 14. In the examples which are shown, an adhesive strip 13, 14 is mounted here respectively at both margin regions 15.

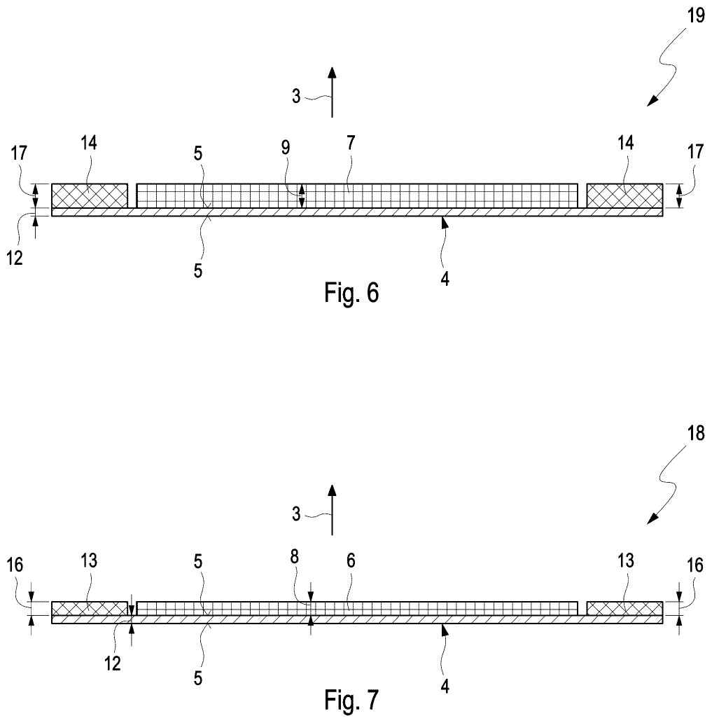

As can be seen for example from FIGS. 3 to 7, here the sides 5, spaced apart from one another by means of the first spacers 3, are stuck to one another by means of first adhesive strips 13, whereas the sides 5 of the membranes 4 spaced apart from one another by means of the second spacers 7, are stuck to one another by means of second adhesive strips 14. As can be seen for example from FIGS. 6 and 7, here a thickness 16 of the first adhesive strips 13 running in stacking direction 3, also designated below as first strip thickness 16, is smaller than a thickness 17 of the second adhesive strips 14 running in stacking direction 3, also designated below as second strip thickness 17. As can be seen further from FIGS. 6 and 7, the first strip thickness 16 corresponds here substantially to the first height 8. In addition, the second strip thickness 17 corresponds substantially to the second height 9.

The adhesive strips 13, 14 in the example embodiments shown, and preferably additionally, are fluidically sealing. Thus, the adhesive strips 13, 14 along their extent seal with respect to the exterior the spacers 6, 7 transversely to the stacking direction 3. This takes place through the arrangement, lying opposite in transverse direction, of the first adhesive strips 13 and of the second adhesive strips 14, therefore transversely to the stacking direction 3 on both sides towards the exterior. As can be seen in particular from FIGS. 1 to 3, here the first spacers 6 and the first adhesive strips 13 and the second spacers 7 and the second adhesive strips 14 are arranged in stacking direction 3 rotated respectively alternately with respect to one another, in the shown example embodiments rotated through 90° or respectively transversely. Hereby, as indicated in FIG. 3, a transverse flow of the humidifier 1 arises. This means that the first flow path 10 runs through the humidifier 1 transversely to the second flow path 11.

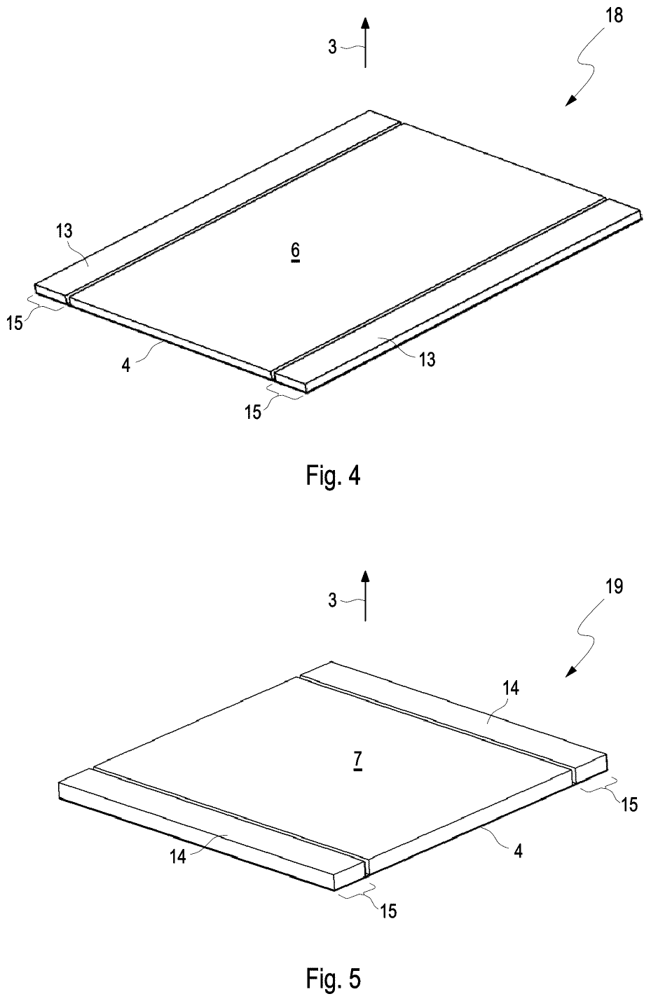

In the example embodiment shown in FIGS. 1 to 3, the production of the humidifier 1 takes place by the alternating stacking on one another in stacking direction 3 of first stacking units 18 and second stacking units 19. Here, FIGS. 4 and 7 show the first stacking unit 18, and FIGS. 5 and 6 show the second stacking unit 19. The first stacking unit 18 accordingly comprises a membrane 4 and a first spacer 6, in addition in the example embodiment which is shown, two first adhesive strips 13. The second stacking unit 19 comprises a membrane 4 and a second spacer 7, in the shown example embodiment in addition two second adhesive strips 14.

As can be seen in particular from FIG. 1, the respective stacking unit 18, 19 can be produced from rolls 20 of the membrane 4, of the spacers 6, 7 and of the adhesive strips 13, 14. Here, the first stacking units 18 are produced from rolls 20 of the membrane 4, of the first spacers 6 and of the first adhesive strips 13 and are cut to the desired size by means of an indicated cutting tool 21. In an analogous manner, the second stacking units 19 are produced from rolls 20 of the membrane 4, of the second spacer 7 and of the second adhesive strips 14, wherein again a cutting to the desired size takes place by means of a cutting tool 21. By a corresponding arrangement of the rolls 20 or respectively of the produced stacking units 18, 19, these can be stacked on one another here without a relative rotation of the stacking units 18, 19 with respect to one another being needed.

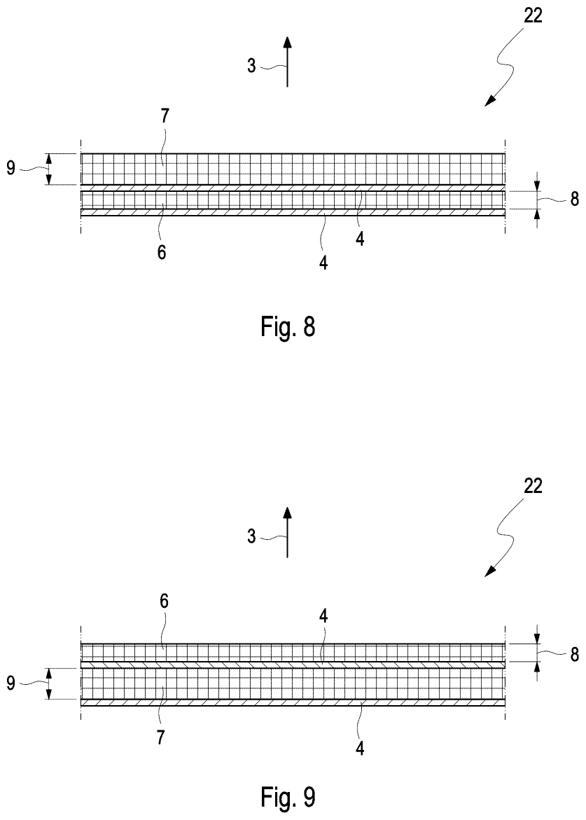

Alternatively to the stacking units 18, 19, it is also conceivable to produce the humidifier 1 by the stacking on one another of the same stacking unit 22 according to one of FIG. 8 or 9, wherein FIGS. 8, 9 respectively show a section through the stacking unit 22, in which the respective adhesive strip 13, 14 is not visible. These stacking units 22 comprise two membranes 4, wherein one of the spacers 6, 7 is arranged between the membranes 4, and the other spacer 6, 7 is arranged on the side of one of the membranes 4 facing away from the first-mentioned spacer 6, 7. In the example embodiment of FIG. 8, the first spacer 6 is arranged between the membranes 4, and the second spacer 7 is arranged on the side 5 of one of the membranes 4 facing away from the first spacer 6. In the example embodiment of FIG. 9, the second spacer 7 is arranged between the membranes 4, and the first spacer 6 is arranged on the side 5 of one of the membranes 4 facing away from the second spacer 7.

The humidifier 1 can be used, as mentioned, in a fuel cell system 2, merely indicated in FIG. 10. The fuel cell system 2 comprises here, in addition to the humidifier 1, at least one fuel cell 23, preferably several fuel cells 23 combined in a fuel cell stack 24. An oxygen-containing reactant, in particular air, is supplied to the at least one fuel cell 23 in operation along the first flow path 10. In addition, a hydrogen-containing reactant is supplied (not shown) to the at least one fuel cell 23. In operation of the at least one fuel cell 23, exhaust gas arises here, which contains moisture, in particular water vapour. The exhaust gas is discharged along the second flow path 11 from the at least one fuel cell 23. The two flow paths 10, 11 lead here through the humidifier 1, wherein the exhaust gas transfers moisture, as second fluid, to the oxygen-containing reactant as first fluid.

1.-8. (canceled)

9. A humidifier for humidifying a first fluid of via a second fluid, comprising:
a plurality of membranes arranged following one another in a stacking direction;
a plurality of spacers including a plurality of first spacers and a plurality of second spacers arranged alternately between the plurality of membranes in the stacking direction, the plurality of spacers spacing the plurality of membranes apart with respect to one another;
wherein a first height of the plurality of first spacers extending in the stacking direction is smaller than a second height of the plurality of second spacers extending in the stacking direction; and
wherein a ratio of the second height to the first height is at least 1.2.

10. The humidifier according to claim 9, wherein:
a first flow path of the first fluid extends between a plurality of first sides of the plurality of membranes which are disposed spaced apart from one another via the plurality of first spacers and face one another; and
a second flow path of the second fluid extends, separate from the first flow path, between a plurality of second sides of the plurality of membranes which are spaced apart from one another via the second spacers and face one another.

11. The humidifier according to claim 10, wherein the first flow path and the second flow path extend relative to one another transversely through the humidifier.

12. The humidifier according to claim 9, wherein the ratio of the second height to the first height is from 1.2 to 3.0.

13. The humidifier according to claim 10, wherein as least one of:
at least one first spacer of the plurality of first spacers lies on at least one of the plurality of first sides; and
at least one second spacer of the plurality of second spacers lies on at least one of the plurality of second sides.

14. The humidifier according to claim 9, wherein at least one of the plurality of spacers is structured as a single piece.

15. The humidifier according to claim 9, wherein:
at least one spacer of the plurality of spacers extends transversely to the stacking direction over a partial portion of an adjacent membrane of the plurality of membranes such that transversely to the stacking direction a partial area remains free at at least one margin region of a side of the adjacent membrane;
an adhesive strip is arranged at the at least one margin region of the adjacent membrane, the adhesive strip extending along the at least one margin region and connecting the adjacent membrane to a membrane of the plurality of membranes that follows the adjacent membrane in the stacking direction.

16. The humidifier according to claim 15, wherein the adhesive strip fluidically seals the at least one spacer toward an exterior along an extent.

17. The humidifier according to claim 15, wherein the adhesive strip extends adjacent to the at least one spacer and has a strip height corresponding to a height of the at least one spacer.

18. The humidifier according to claim 10, wherein:
the first fluid is flowable through the plurality of first spacers; and
the second fluid is flowable through the plurality of second spacers.

19. A humidifier for humidifying a first fluid via a second fluid, comprising:
a plurality of first flow paths through which the first fluid is flowable;
a plurality of second flow paths through which the second fluid is flowable;
a plurality of membranes and a plurality of spacers arranged following one another in a stacking direction in an alternating manner;
the plurality of membranes each having a first surface and a second surface disposed opposite one another;
the plurality of membranes including a plurality of first membranes and a plurality of second membranes arranged alternately in the stacking direction;
the plurality of spacers including a plurality of first spacers and a plurality of second spacers arranged alternately in the stacking direction;
the plurality of first spacers each disposed between the first surface of an adjacent first membrane and the second surface of an adjacent second membrane, which face one another and define one of the plurality of first flow paths;
the plurality of second spacers each disposed between the second surface of an adjacent first membrane and the first surface of an adjacent second membrane, which face one another and define one of the plurality of second flow paths;
wherein the plurality of first spacers each have a first height in the stacking direction, the plurality of second spacers each have a second height in the stacking direction, and a ratio of the second height to the first height is at least 1.2.

20. The humidifier according to claim 19, wherein the ratio of the second height to the first height is from 1.2 to 3.0.

21. The humidifier according to claim 19, wherein the plurality of first flow paths are separated from the plurality of second flow paths.

22. The humidifier according to claim 19, wherein the plurality of first flow paths and the plurality of second flow paths extend transversely to one another.

23. The humidifier according to claim 19, wherein:
the first fluid is flowable through the plurality of first spacers; and
the second fluid is flowable through the plurality of second spacers.

24. The humidifier according to claim 19, wherein:
the plurality of first spacers each contact the first surface of the adjacent first membrane and the second surface of the adjacent second membrane; and
the plurality of second spacers each contact the second surface of the adjacent first membrane and the first surface of the adjacent second membrane.

25. The humidifier according to claim 19, wherein:
the plurality of first spacers each extend along a central portion of the first surface of the adjacent first membrane and a central portion of the second surface of the adjacent second membrane; and
the plurality of second spacers each extend along a central portion of the second surface of the adjacent first membrane and a central portion of the first surface of the adjacent second membrane.

26. The humidifier according to claim 25, wherein:
the plurality of first spacers are each arranged between a pair of first adhesive strips that connect the first surface of the adjacent first membrane and the second surface of the adjacent second membrane to one another; and
the plurality of second spacers are each arranged between a pair of second adhesive strips that connect the second surface of the adjacent first membrane and the first surface of the adjacent second membrane to one another.

27. The humidifier according to claim 26, wherein:
the first adhesive strips each have a first strip height that corresponds to the first height of the plurality of first spacers; and
the second adhesive strips each have a second strip height that corresponds to the second height of the plurality of second spacers.

28. The humidifier according to claim 19, wherein at least one of the plurality of spacers is structured as a single piece.
